(19) United States
(12) Patent Application Publication
(10) Pub. No.: US 2006/0167712 A1
(43) Pub. Date: Jul. 27, 2006

(54) Franchise arrangement that supports physician provided medical services

(76) Inventors: Charles F. Engelmann, Scottsdale, AZ (US); Ross E. Stromberg, Healdsburg, CA (US); Matthew C. Rubin, Scottsdale, AZ (US)

Correspondence Address: HARNESS, DICKEY & PIERCE, P.L.C., P.O. BOX 828, BLOOMFIELD HILLS, MI, 48303, US

(21) Appl. No.: 11/245,954

(22) Filed: Oct. 7, 2005

Related U.S. Application Data
(60) Provisional application No. 60/616,830, filed on Oct. 7, 2004.

(51) Int. Cl. G06Q 99/00

(52) U.S. Cl. 705/1

(57) ABSTRACT

A franchise arrangement is provided that supports physician administered medical services. The franchise arrangement include: a franchisor licensed to practice medicine by a government entity; and a franchisee licensed to practice medicine by the same government entity. The franchisee includes at least one practicing physician administering medical services in accordance with an agreement with the franchisor.

### CROSS-REFERENCE TO RELATED APPLICATIONS

This application claims the benefit of U.S. Provisional Application No. 60/616,830, filed on Oct. 7, 2004. The disclosure of the above application is incorporated herein by reference.

### FIELD OF THE INVENTION

The present invention relates generally to franchise arrangements and, more particularly, to a business model that enables structured authority over and lay investor participation in entities which offer physician administered medical services on a national basis.

### BACKGROUND OF THE INVENTION

Typical franchise arrangements consist of a franchisor and a franchisee organized as general purpose business entities; a franchisor sells franchises to general purpose business entities in several states, and the franchisee sells goods or provides services pursuant to and subject to usually stringent requirements imposed by the franchisor in the franchise agreement. However, the provision of medical services does not fit the typical franchise arrangement because many states adhere to the corporate practice of medicine doctrine, which prohibits general purpose business entities from employing a physician or unduly interfering with a physician's professional decision-making.

Therefore, it is desirable to provide a business model that enables structured authority over and lay investor participation in entities which offer physician administered medical services. This model provides the franchisor or business entity the legal authority to control franchise operations in compliance with state corporate practice of medicine concerns.

### SUMMARY OF THE INVENTION

In accordance with the present invention, a franchise arrangement is provided that supports physician administered medical services. The franchise arrangement include: a franchisor licensed to practice medicine by a government entity; and a franchisee licensed to practice medicine by the same government entity. The franchisee includes at least one practicing physician administering medical services in accordance with an agreement with the franchisor.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a diagram illustrating an exemplary franchise arrangement in accordance with the present invention;

FIG. 2 is a diagram illustrating an exemplary franchise arrangement that extends franchise operation outside of the state in which the franchisor is formed;

FIG. 3 is a diagram illustrating another exemplary franchise arrangement that employs a practicing entity to extend franchise operation outside of the state in which the franchiser is formed;

FIG. 4 is a diagram illustrating an exemplary franchise arrangement that uses a professional corporation organized in the intended state of franchise operation; and

FIG. 5 is a diagram illustrating another exemplary franchise arrangement that uses a professional corporation organized in the intended state of franchise operation.

### DETAILED DESCRIPTION OF THE PREFERRED EMBODIMENTS

In many states, only professional entities, such as professional corporations and professional limited liability companies (PLLCs) may employ physicians to practice medicine. In addition, any entity involved in the practice of medicine across multiple states must ensure that professional medical services rendered in each state meet the standards of practice set in each state. Against this backdrop, a franchise arrangement was developed to satisfy state “corporate practice of medicine” doctrine, which restricts and/or prohibits a corporation or other entity organized for general business purposes from employing and unduly interfering with a physician's practice of medicine. While the following description is provided with reference to a state as being the governing entity, it is readily understood that the present invention may extend to provinces, territories, counties, cities or other types of governing entities which may register business entities as corporations and/or license entities to practice medicine.

A franchise arrangement is generally comprised of a franchisor and at least one franchisee. The franchisor is registered as a corporate entity with a given state and licensed to practice medicine within the same state. Registration as well as licensing requirements may vary between different states. For example, in Arizona, an entity licensed to practice medicine must have a physician licensed to practice medicine in Arizona hold at least a one percent ownership interest in the entity. In addition, this physician must possess a controlling interest in the appointment of the directors of the licensed entity. It is readily understood that different states may have different registration and/or licensing requirements.

The franchisee is likewise registered as a corporate entity with the same state as the franchisor. Although the franchisee is preferably licensed to practice medicine with the same state as the franchisor, it is contemplated that the franchisee may be additionally licensed or exclusively licensed by a different state in which medical services will be administered. In any case, the franchisee will qualify to practice medicine in the state in which medical services are being administered and will use locally-licensed physicians to render medical services in that state. Protocols promulgated by the franchisor will be approved by either the locally-licensed medical director of the franchise operations or a locally-licensed medical consultant to ensure compliance with each local state's standard of medical practice. In this way, the proposed franchise arrangement provides the franchisor with the legal authority to control franchise operations, including obligations to abide by clinical aspects and medical protocols developed by the franchisor, in compliance with state corporate practice of medicine concerns.

In an exemplary embodiment, the proposed franchise arrangement uses the Arizona PLLC as the franchisee vehicle. Unlike most states, Arizona law permits non-physicians to invest in a PLLC, as long as at least one physician is a member in the PLLC. The physician member may be employed as the medical director of the franchisee, thereby allowing the physician to realize income from his or her services as medical director as well as share in the profits of the franchise as an investor. Alternatively, it is envisioned that the franchisee may hire a physician distinct from the physician member to serve as the medical director. Furthermore, the Arizona PLLC provides non-physician members or other types of investors the opportunity to realize revenues from the franchise. However, it is readily understood that other types of business entities may be used and/or similar franchise arrangements may be permissible (either today or in the future) under other state laws.

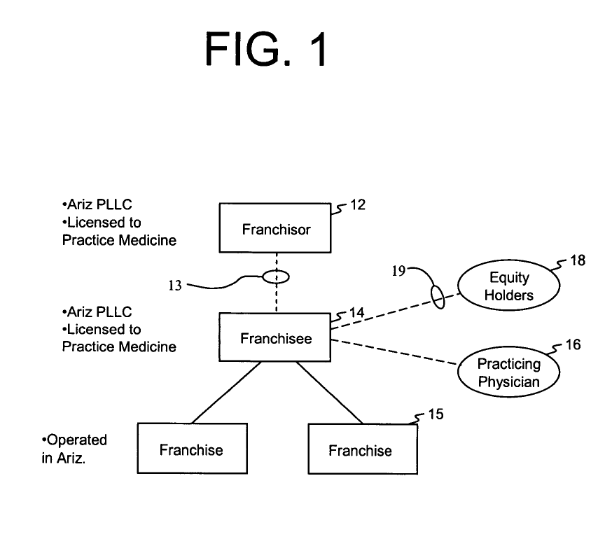

FIG. 1 illustrates an exemplary embodiment of the proposed franchise arrangement, where the franchisee exclusively operates its franchises in Arizona. The franchisor 12 is organized as a PLLC under Arizona law. In addition, the franchisor 12 is licensed to practice medicine in Arizona. Likewise, the franchisee 14 is organized as an Arizona PLLC and licensed to practice medicine in Arizona. The franchisee 14 further employs at least one practicing physician 16 who is licensed to practice medicine in Arizona and thus administers medical services at its franchises. Obligations regarding medical protocols as well as other aspects of franchise operation are set forth in a franchise agreement 13 between the parties. It is envisioned that other types agreements (i.e., Uniform Franchise Offering Circular, operating agreement, employee agreement with practicing physicians, etc.) may be used to govern the operation of and/or the relationship between the franchisor and the franchisee. Since the franchisee is licensed to practice medicine in the same state as the franchisor, there should be no corporate medicine issues as to any of franchises 15 it operates in Arizona.

In operation, the franchisee bills and collects on its own behalf as a professional entity. If the franchisee is entirely physician owned, then all profits go to the physician equity holders. If the franchisee is not entirely physician owned, then the franchisee may also bill on behalf of the physician for his or her professional services. In this situation, the physician is paid a fixed monthly fee under an employment agreement with the franchisee. As an equity holder, the physician may also be entitled to share in the profits. In addition, all of the equity holders 18 in the franchisee may be subject to an equity holder agreement 19. Amongst other things, this agreement authorizes non-physician owners to find a replacement for a physician equity holder who is no longer associated with the franchisee.

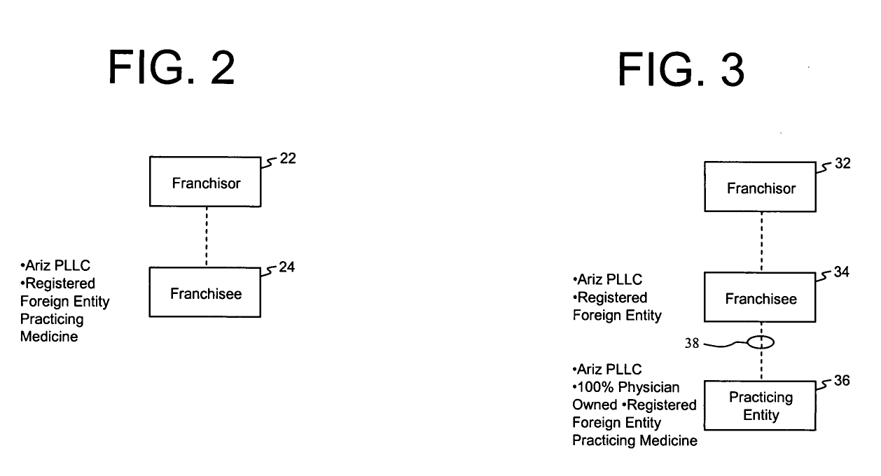

To extend this franchise arrangement outside of Arizona, several other models have been developed. In one exemplary model, the Arizona PLLC can qualify to do business in the state of franchise operation as a foreign PLLC as shown in FIG. 2. In this model, the franchisee 24 does not need to be registered to practice medicine in Arizona, but does register in the state of operation as a foreign business entity practicing medicine; otherwise, the relationship between the franchisor 22 and franchisee 24 remains the same as described above. In this way, the franchisee 24 may own and operate local franchises in these states, so long as the professional medical services are rendered by physicians licensed by the state in which its franchise operates. To operate franchises in multiple states, it is envisioned that the franchisee may need to register with each additional state or, alternatively, establish a distinct franchisee for operating in each different state.

In some states, an Arizona PLLC can register as a foreign business entity practicing medicine so long as all of the equity holders are licensed physicians. In other states, an Arizona PLLC can register as a foreign business entity practicing medicine so long as all of the equity holders are physicians licensed in the state in which the franchise operates. If either of these criteria is met by the desired franchisee, then the model described above may be used to extend the franchise arrangement into these states. In either scenario, medical services must be rendered exclusively by physicians licensed in the state in which it operates.

When non-physician investors are involved in the franchisee, another exemplary model may be used to extend the franchise arrangement into these states. Referring to FIG. 3, this exemplary model employs a third Arizona PLLC as a practicing entity 36. In this model, the franchisee 34 is registered in the state of operation as a foreign business entity, but cannot qualify to practice medicine. Moreover, the franchisee 34 may include non-physician investors as described above. On the other hand, the practicing entity 36 is entirely physician owned. In this way, the practicing entity 36 may register in the state of operation as a foreign business entity practicing medicine.

In operation, the franchisee employs a locally-licensed physician to provide medical direction to the practicing entity. In accordance with a management and/or professional services agreement 38, the franchisee bills and collects on behalf on the practicing entity and reimburses it for professional services administered by the practicing entity. Pursuant to the franchise agreement, this management agreement also specifies the treatment modalities, protocols and procedures for the practicing entity. The franchisee also sublicenses to the practicing entity any marks, know-how or other intellectual property needed to operate the franchise. Other aspects of the franchise arrangement are as described above.

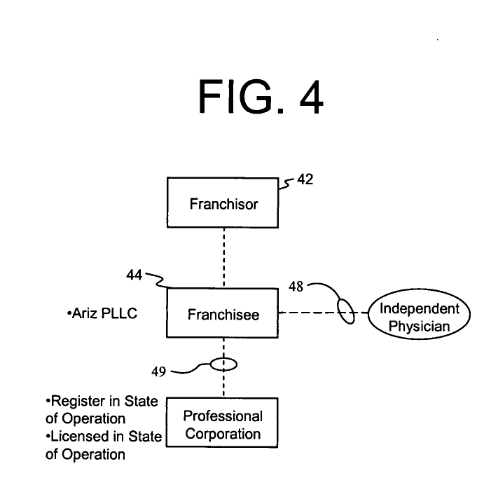

In FIG. 4, an Arizona PLLC may register to do business with the intended state of franchise operation, but is not permitted to practice medicine in these states. In this model, the Arizona PLLC serving as a franchisee 44 preferably provides the non-clinical aspects of the franchise; whereas, a professional corporation 46 organized in the intended state of franchise operation is used to administer medical services in the state.

The franchisee 44 will provide oversight of the professional corporation as to compliance with the franchise agreement. To do so, the franchisee 44 enters into an agreement 48 with an independent physician licensed to practice medicine in the state of operation. This physician will review and approve clinical aspects and medical protocols developed by the franchisor 42 to ensure conformity with local law, thereby addressing any state corporate practice of medicine concerns.

In operation, the franchisee bills and collects on behalf of the professional corporation and reimburses it for professional services administered in accordance with a management and/or professional services agreement 49. The franchisee also sublicenses to the professional corporation any marks, know-how or other intellectual property needed to operate the franchise. Other agreements associated with the franchise arrangement are as described above.

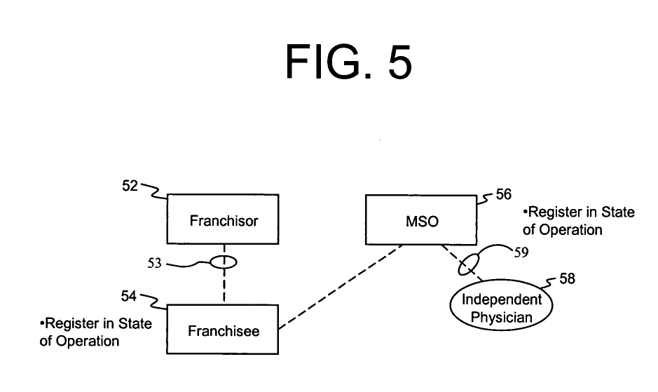

When an Arizona PLLC cannot register to do business nor practice medicine in an intended state of operation, non-physician investors may only invest in a management services organization as shown in FIG. 5. In this exemplary model, a professional corporation organized in the state of franchise operation is again used to administer medical services in the state. The professional corporation also serves as the franchisee 54 that contract with the franchisor. Thus, the franchise agreement 53 is between the franchisor 52 and the professional corporation 54.

Likewise, the management services organization 56 is organized in the state in which the franchise operates. The professional corporation contracts with the management services organization at 57 for selective or turn key management services, including but not limited to equipment, billing and collection services, non-clinical personnel and other administrative services. Thus, the management services organization bills and collects on behalf on the professional corporation. The professional corporation in turn reimburses the management services organization for services performed. The professional corporation may sublicense to the management services organization any marks, know-how or other intellectual property needed to operate the franchise.

To ensure conformity with local law, the management services organization 56 contracts with an independent physician 58 licensed to practice medicine in the state of operation. This physician will review and approve clinical aspects and medical protocols developed by the franchisor. This approach again addresses concerns relating to corporate practice of medicine.

The description of the invention is merely exemplary in nature and, thus, variations that do not depart from the gist of the invention are intended to be within the scope of the invention. For instance, it is envisioned that the broader aspects of the inventive concept extend outside of the franchise arrangement. Such variations are not to be regarded as a departure from the spirit and scope of the invention.

What is claimed is:

1. A franchise arrangement that supports physician administered medical services, comprising:
a franchisor licensed to practice medicine by a government entity; and
a franchisee licensed to practice medicine by the government entity and having at least one practicing physician administering medical services in accordance with an agreement with the franchisor.

2. The franchise arrangement of claim 1 wherein the franchisor and the franchisee are registered as corporations with the government entity.

3. The franchise arrangement of claim 1 wherein the franchisor has an ownership interest held by a physician licensed by the government entity.

4. The franchise arrangement of claim 3 wherein the franchisor includes one or more directors and the physician possesses a controlling interest over appointment of the directors of the franchisor.

5. The franchise arrangement of claim 1 wherein the franchisor has an ownership interest held by a non-physician.

6. The franchise arrangement of claim 1 wherein the franchisee has an ownership interest held by a physician licensed by the government entity.

7. The franchise arrangement of claim 6 wherein the franchisee includes one or more directors and the physician possesses a controlling interest over appointment of franchisees' directors.

8. The franchise arrangement of claim 1 wherein the franchisee has an ownership interest held by a non-physician.

9. The franchise arrangement of claim 1 wherein the franchisee operates more than one franchise which administers medical services in accordance with the agreement with the franchisor.

10. The franchise arrangement of claim 1 wherein the franchisee is registered as a foreign business entity able to practice to medicine with a different government entity.

11. The franchise arrangement of claim 10 wherein the franchisee operates at least one franchise in the different government entity.

12. The franchise arrangement of claim 10 wherein the at least one practicing physician is licensed to practice medicine by the different government entity.

13. The franchise arrangement of claim 1 wherein at least one of the franchisor or the franchisee is registered as a professional corporation or a professional limited liability company.

14. The franchise arrangement of claim 1 wherein the franchisor and franchisee are further defined as personal limited liability corporations registered in the state of Arizona.

15. A franchise arrangement that supports physician administered medical services, comprising:
a franchisor registered as a corporation with a government entity and licensed to practice medicine by the government entity; and
a franchisee registered as a corporation with the government entity, but licensed to practice medicine by a different government entity.

16. The franchise arrangement of claim 15 wherein the franchisee is registered as a foreign business entity with the different government entity.

17. The franchise arrangement of claim 15 wherein the franchisee has at least one practicing physician licensed to practice medicine by the different government entity and whom administers medical services in the different government entity in accordance with an agreement with the franchisor.

18. The franchise arrangement of claim 15 wherein at least one of the franchisor or the franchisee has an ownership interest held by a physician licensed by the government entity.

19. The franchise arrangement of claim 15 wherein at least one of the franchisor or the franchisee has an ownership interest held by a non-physician.

20. A franchise arrangement that supports physician administered medical services, comprising:
a franchisor registered as a corporation with a government entity and licensed to practice medicine by the government entity;
a franchisee registered as a corporation with the government entity and licensed to practice medicine by the government entity; and
a practicing entity registered as a corporation with the government entity, but licensed to practice medicine by a different government entity, wherein the practicing entity having at least one practicing physician whom administers medical services in the different government entity in accordance with an agreement with the franchisee.

21. The franchise arrangement of claim 20 wherein the practicing entity is registered as a foreign business entity with the different government entity.

22. The franchise arrangement of claim 20 wherein the at least one practicing physician is licensed to practice medicine by the different government entity.

23. The franchise arrangement of claim 20 wherein the practicing entity is entirely owned by physicians.

24. The franchise arrangement of claim 20 wherein at least one of the franchisor or the franchisee has an ownership interest held by a physician licensed by the government entity.

25. The franchise arrangement of claim 20 wherein at least one of the franchisor or the franchisee has an ownership interest held by a non-physician.

26. A franchise arrangement that supports physician administered medical services, comprising:
a franchisor registered as a corporation with a government entity and licensed to practice medicine by the government entity;
a franchisee registered as a corporation with the government entity and registered as a foreign business entity with a different government entity; and
a practicing entity registered as a corporation with the different government entity and licensed to practice medicine by the different government entity, wherein the practicing entity having at least one practicing physician whom administers medical services in the different government entity in accordance with an agreement with the franchisee.

27. The franchise arrangement of claim 26 wherein the franchisee contracts with a physician licensed to practice medicine in the different government entity to ensure compliance of the medical services with applicable law of the different government entity.

28. The franchise arrangement of claim 26 wherein at least one of the franchisor or the franchisee has an ownership interest held by a physician licensed by the government entity.

29. The franchise arrangement of claim 26 wherein at least one of the franchisor or the franchisee has an ownership interest held by a non-physician.

30. A franchise arrangement that supports physician administered medical services, comprising:
a franchisor registered as a corporation with a government entity and licensed to practice medicine by the government entity;
a franchisee registered as a corporation with a different government entity and having at least one practicing physician whom administers medical services in the different government entity in accordance with an agreement with the franchisor; and
a management services organization registered as a corporation with the different government entity, wherein the management services organization contracts with a physician licensed to practice medicine in the different government entity to ensure the medical services administered by the franchisee comply with applicable law of the different government entity.
